(19) United States
(12) Patent Application Publication
(10) Pub. No.: US 2014/0095383 A1
(43) Pub. Date: Apr. 3, 2014

(54) SYSTEM FOR ANONYMOUS FUNDS TRANSFER USING ADHOC STAGING ACCOUNTS

(71) Applicant: BINDU RAMA RAO, LAGUNA NIGUEL, CA (US)

(72) Inventor: BINDU RAMA RAO, LAGUNA NIGUEL, CA (US)

(21) Appl. No.: 14/102,509

(22) Filed: Dec. 11, 2013

Related U.S. Application Data
(63) Continuation-in-part of application No. 14/093,521, filed on Dec. 2, 2013.
Application No. 14/093,521 is a continuation-in-part of application No. 13/277,300, filed on Oct. 20, 2011, now Pat. No. 8,639,602.

(51) Int. Cl. G06Q 20/38; G06Q 20/10

(52) U.S. Cl. CPC G06Q 20/383; G06Q 20/1085
USPC 705/43; 705/44

(57) ABSTRACT

A system for conducting funds transfer using a sender mobile device and a recipient mobile device and using adhoc staging accounts that only exist for one-time use during the funds transfer. In one embodiment, a sender can use the source ATM or his mobile device to initiate a funds transfer, or select a bank account online for funds transfer. Similarly, the recipient uses the recipient mobile device to receive funds into a bank account or to receive digital currency into a digital wallet. The recipient provides a transaction id and security information (such as a security token, for example) when prompted by the user interaction screens on the recipient mobile device, for example. The sender and the recipient need not have any bank accounts to conduct funds transfer.

### CROSS REFERENCES TO RELATED APPLICATIONS

The present patent application is a continuation-in-part (CIP) of, claims priority to, and makes reference to U.S. non-provisional patent Ser. No. 14/093,521 filed on 2 Dec. 2013, entitled “SYSTEM FOR FUNDS TRANSFER USING SOURCE ATM AND DELIVERING ATM”, docket number BRR2013ATMFT01, which in turn is a continuation-in-part (CIP) of, claims priority to, and makes reference to U.S. non-provisional patent Ser. No. 13/277,300 filed on Oct. 20, 2011, entitled “SYSTEM FOR AGENT ASSISTED MOBILE FUNDS TRANSFER AND MOBILE BANKING”, docket number BRR092011U1. The complete subject matter of both the above-referenced United States patent applications is hereby incorporated herein by reference in their respective entirety.

### BACKGROUND

1. Technical Field

The present invention relates generally to funds transfer; and, more particularly to use of a server infrastructure for conducting funds transfer between mobile devices.

2. Related Art

Cell (mobile) phones are widely used as mobile devices to communicate anywhere in the world. Some of them are very simple devices capable of voice communication alone. Many other today's mobile devices are used for multiple purposes, other than voice communication, in any convenient location. GSM based Cell phones have a SIM card that provides access to cellular networks and support for interactions with a server in a cellular network. These phones also have camera to take photos, and microphones to record voice.

People have been using automatic teller machines (ATM) to withdraw cash from their bank accounts, to deposit checks and to check on account balances. However, using an ATM requires a user to a) have an active bank account, b) use an ATM card and c) have PIN codes or passcodes to gain access to an ATM machine.

Quite a few people, mostly those who are poor or underage, do not have access to such bank accounts, especially those that require a minimum balance of a thousand dollars or so, or those that deduct monthly fees to maintain an account. Such people are cutoff from banking services essentially. They cannot receive money sent by others, as they cannot get wire transfers, they cannot get money transferred through ACH services, etc.

It is very hard, and very expensive otherwise, for poor people who cannot afford to pay monthly fees to maintain a bank account, or to maintain a high minimum balance, to receive money that may be transferred by their family or friends when in need of such funds. It is very difficult for someone to send money to their family members or friends when those intended recipients do not have a bank account, cannot use wire transfer services, cannot have money transferred to their bank accounts somehow, or even cash a check without having a significant portion of that money taken away by check cashing services (especially when they cannot afford such fees), and besides, sending a check to be cashed is a slow process and could take days to be received.

Quite often, people do not have bank accounts, but they want to send or receive funds from others. All they have is a mobile phone. It is almost impossible to conduct banking or conduct funds transfers without bank accounts. This is a major problem for poor people and for people who do not own or know how to operate bank accounts, but still need to conduct payments, conduct funds transfers, etc.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a system 105 supporting a plurality of users for managing funds transfer and banking

FIG. 2 is a perspective block diagram of a system supporting a plurality of mobile devices used by a plurality of users for managing funds transfer and banking, that comprises a server infrastructure communicatively coupled to both a first mobile device and a recipient's mobile device, and also to a source ATM and a delivering ATM.

FIG. 3 is a perspective block diagram of a system supporting a plurality of mobile devices used by a plurality of users for managing anonymous funds transfer and banking.

### DETAILED DESCRIPTION OF THE DRAWINGS

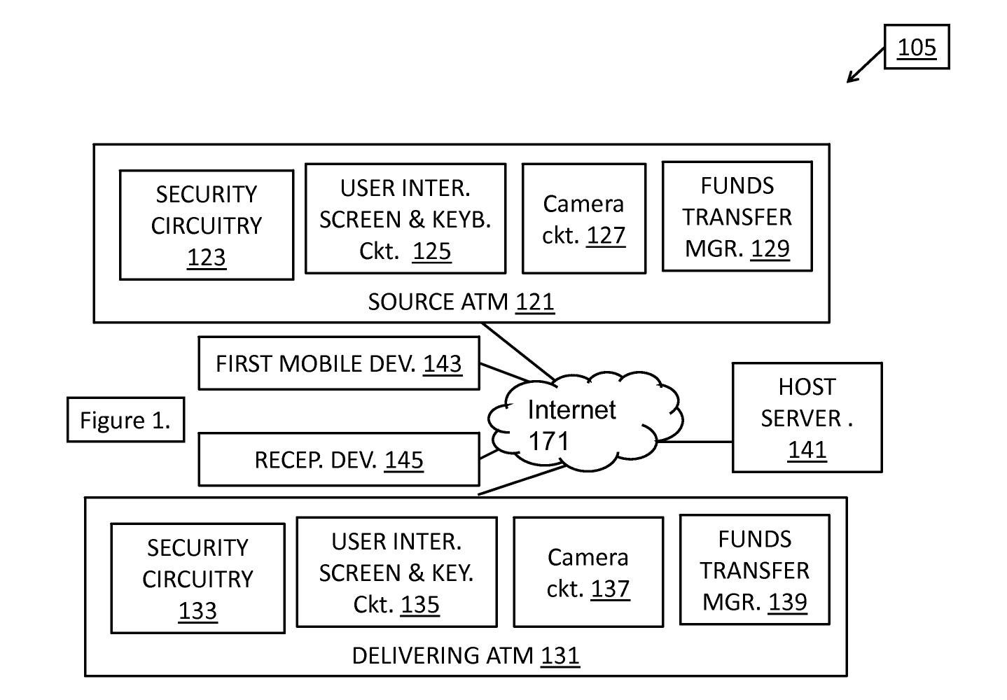

FIG. 1 is a perspective block diagram of a system 105 supporting a plurality of users for managing funds transfer and banking. A user, using the first mobile device 143 can make anonymous funds transfer from the first mobile device 143 to a recipient device 145 (which can be a laptop, tablet or a cellular phone, etc.). The user need not have a bank account, the recipient does not need bank account, and in some embodiments, an adhoc bank account is created on-the-fly to enable depositing the funds to be transferred by the user (the sender) which is subsequently deleted at the completion of the funds transfer.

The system 105 comprises a host server 141, which gets a confirmation of receipt of funds for a funds transfer from a sender along with recipient device's 145 particulars (for example mobile phone number, IMEI, IP address, etc.) and fund transfer instructions, wherein the receipt of funds is associated with a transfer amount. The host server 141 communicates at least a transaction id representing the funds transfer to the recipient device 145 for notifying a recipient. The host server 141 allows identification of the funds transfer based at least on the transaction id, thereby enabling redemption of the transfer amount by the recipient. The host server 141 delivers the transfer amount or a subset thereof to the recipient upon successfully verifying the transaction id. The host server 141 communicates a notification to the first mobile device 143 of the sender regarding the successful delivery of the transfer amount to the recipient.

The delivery of funds from the sender in one embodiment occurs when the sender identifies a sender account associated with the sender and authorizes withdrawal of the transfer amount from the sender account. In a related embodiment, the delivery of the transfer amount to the recipient occurs when the recipient identifies a recipient account associated with the recipient and authorizes a deposit of the transfer amount to the recipient account.

In one embodiment, the delivery of the transfer amount or a subset thereof (after deductions of any transfer charges, fees, etc. for example) to the recipient occurs after the recipient identifies a recipient account at a recipient bank, wherein the recipient account at the recipient bank get credited with the transfer amount or a subset thereof. In a related embodiment, the recipient identifies the recipient account and the recipient bank online employing the recipient device 145 after receiving the communication with the transaction id, such as in a notification sent from the host server 141.

In one embodiment, delivering the transfer amount or a subset thereof (after deducting transaction fees, etc., for example, from the transfer amount specified by the sender) to the recipient occurs after the recipient identifies an ATM 131 (called delivering ATM 131 for the recipient) at a specific location for collecting the transfer amount, or agrees to use an ATM 31 at a location that is recommended (such as by the sender of the host server 141), as a venue for receiving the transfer amount or a subset thereof in the form of currency notes.

The system 105 also supports delivering funds transferred by a sender in the form of digital currency or digital money. The funds transferred can be in a local currency or can be as digital currency, and the delivered funds can be in another local currency or even in another form of digital currency. Thus, the system 105 facilitates delivering the transfer amount or a subset thereof to the recipient in the form of a digital currency of choice specified by the recipient, for example, or in the choice of a digital currency specified by the sender. Similarly, when funds are transferred in the form of USD, Yen or other forms of formal traditional currencies, delivery of the transfer amount or a subset thereof to the recipient occurs in a currency of choice specified by the recipient, in one related embodiment.

In one related embodiment, receipt of funds from the sender occurs in a currency of choice specified by the recipient, and in another related embodiment, receipt of funds from the sender occurs in a digital currency of choice specified by the recipient.

The system 105 facilitates determining a bank account for the recipient wherein the funds can be delivered. For example, the host server 141 searches for an appropriate bank account to use by searching through the old history of transactions, by searching through sender preferences, by searching through known accounts (if any) for the recipient, etc. Thus, recipient account and the recipient bank are determined by the host server 141 based on a search conducted or based on a user preference stored, before delivering of the transfer amount or a subset thereof to the recipient.

In one embodiment, the system 105 comprises a source automated teller machine (ATM) 121 that initiates a funds transfer of a specified first amount to a recipient based on a funds transfer instructions received from a sender, and a delivering ATM 131 that conducts funds transfer of the specified first amount to the recipient.

The source ATM 121 is used by a sender of funds and the delivering ATM 131 is used by a recipient of funds transferred by the sender. The sender provides an identification of the receiver along with funds (in the form of a cash, or a check, for example) to be transferred to the source ATM 121, and the source ATM 121 communicates the amount to be delivered, along with a transaction id and an optional security token (such as a one-time use security token, for example). The delivering ATM 131 uses it to verify the identity of the recipient before disbursing the transferred funds (in the form of cash, for example). The communication of details of the funds transfer activity occurs in one of several ways—by out of band communication by the sender to the recipient, such as over a phone call or email. It also occurs via an SMS message or instant message sent by the sender to the recipient, or sent by a server of another system communicatively coupled to the source ATM 121, etc. It also occurs in some cases via email sent to the recipient. Other means of communicating the funds transfer details to the recipient and the delivering ATM are also contemplated. The communication of funds transfer details by the sender to the recipient is accompanied by the communication of similar details of the funds transfer transaction to the delivering ATM 131, such communication occurring directly from the source ATM 121 or via a server infrastructure or third party system communicatively coupled to both the source ATM and he delivering ATM.

The source ATM 121 comprises a user interaction screen and keyboard circuitry 125 that helps a user view displayed screens and interact using keyboard, gestures and audio inputs. It also comprises a funds transfer manager 129 that facilitates initiation, conducting, tracking and management of funds transfer activities. It comprises a security manager 123 that facilitates user authentication, verification of user's rights to conduct banking and funds transfer activities, and secure communications of financial transactions and data. It has a camera circuitry 127 that helps capture a picture of the user or a video clip of users activities that can be shared with other ATMs in a network, stored for future reference or forwarded to users on mobile devices for their review and approval, if necessary.

Similarly, the delivering ATM 131 comprises a user interaction screen and keyboard circuitry 135 that helps a user view displayed screens and interact using keyboard, gestures and audio inputs. It also comprises a funds transfer manager 139 that facilitates initiation, conducting, tracking, delivering of funds and management of funds transfer activities. It comprises a security manager 133 that facilitates user authentication, verification of user's rights to conduct banking and funds transfer activities, verification of user input presented by the recipient, and secure communications of financial transactions and data. It has a camera circuitry 137 that helps capture a picture of the user or a video clip of users activities that can be shared with other ATMs in a network, stored for future reference or forwarded to users on mobile devices for their review and approval, such as a sender who initiated a funds transfer, if necessary.

In one embodiment, a sender can use the source ATM 121 to initiate a funds transfer, deliver cash into it, or a check, or select a bank account with sufficient funds available, to be the source of funds. The sender can even use his ATM card to login to the source ATM and provide a passcode or PINcode (such as a 4 digit PINcode) if challenged to be able to use the source ATM 121. Similarly, the recipient uses the delivering ATM 131 to receive funds, providing a transaction id and security information (such as a security token, for example) when prompted by the user interaction screen and keyboard circuitry 135. In a related embodiment, the recipient uses his own ATM card to login to the delivering ATM, and authenticate himself, before being able to get the funds transferred. In a different embodiment, the recipient is only prompted to enter a transaction id and a security information before getting funds (in cash form, for example), and does not have to use his own ATM card to access the funds.

In one embodiment, the sender provides, via the sender's ATM 121 (actually screens provided by user interaction screen & keyboard circuitry 125 of the sender's ATM 121) an identity of the recipient, the source of funds (such as a bank account, cash provided, a check provided, or a credit card information, etc.), and optionally the phone number of the recipient's mobile device to which a notification is to be sent, notifying the sender to come to the location of the delivering ATM to get the funds transferred to him.

In one embodiment, the sender and the recipient need not have any bank accounts to conduct funds transfer using the source ATM and the delivering ATM. In addition, the sender can specify that funds be disbursed only after verification of the recipient by the sender, such as by viewing the sender's digital photo on the sender's mobile device, or at the least, verification of a transaction id and security information (sent to the recipient somehow). The recipient's mobile device, if accessible, is used to provide a notification message with details of the funds transfer transaction and details of where the delivering ATM 131 is located.

In one embodiment, the system 105 for conducting funds transfer uses a sender mobile device 143 and a recipient mobile device 145 and uses an adhoc staging account that only exist for one-time use during the funds transfer. In a related embodiment, a sender can use the source ATM 121 or his mobile device 143 to initiate a funds transfer, or select a bank account online for funds transfer. Similarly, the recipient uses the recipient mobile device 145 to receive funds into a bank account or to receive digital currency into a digital wallet (such as those in the recipient device 145, or those used online in a website). The recipient provides a transaction id and security information (such as a security token, for example) when prompted by the user interaction screens on the recipient mobile device 145, for example. The sender and the recipient need not have any bank accounts to conduct funds transfer, and they can conduct fund transfers just using their corresponding mobile devices.

The recipient device 145 is a tablet, a mobile phone, a handheld computer, a laptop, a PC, etc. in different embodiments.

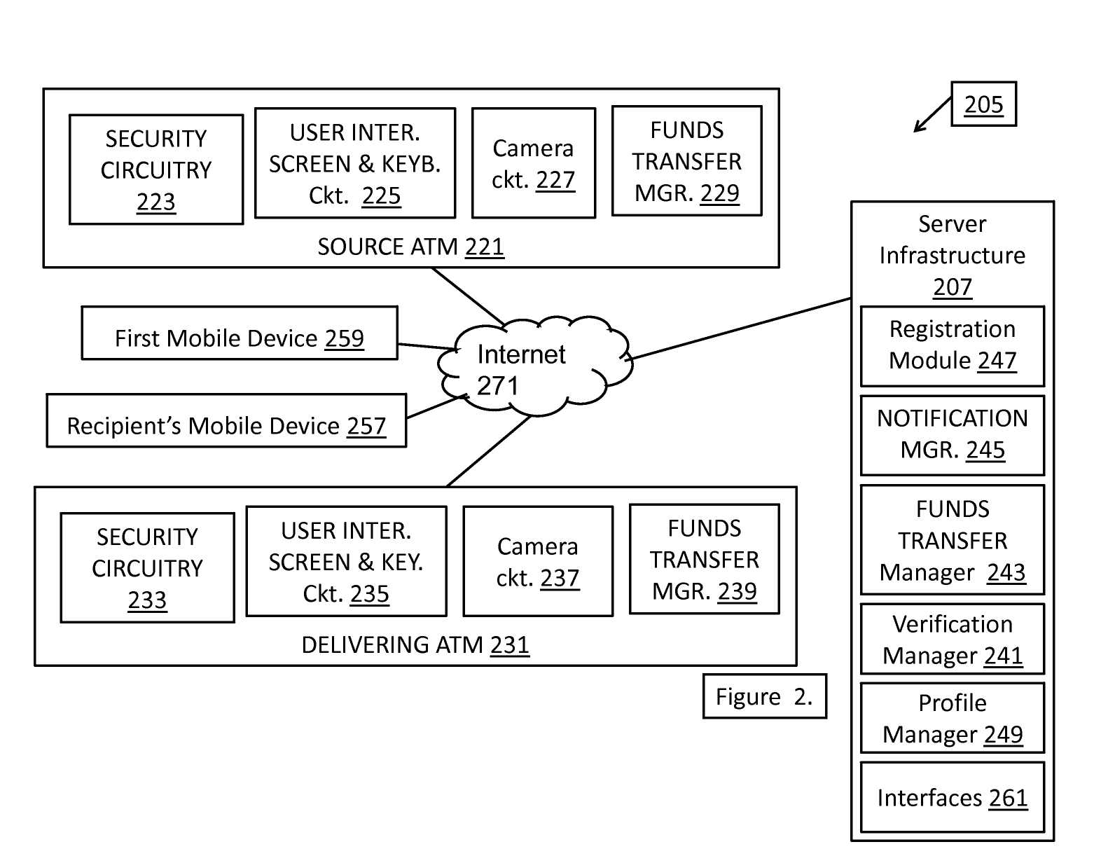

FIG. 2 is a perspective block diagram of a system 205 supporting a plurality of mobile devices used by a plurality of users for managing funds transfer and banking, that comprises a server infrastructure 207 communicatively coupled to both a first mobile device 259 and a recipient's mobile device 257, and also to a source ATM 221 and a delivering ATM 231.

The system 205 provides an anonymous payment service for a user using the first mobile device 259 who intends to transfer funds to another user using the second device, the recipient's mobile device 257. The server infrastructure 207 enables an electronic payment between a first user and a second user without provision of an account number or name from at least the first user. The server infrastructure 207 in the system 205 comprises at least one computer that is configured to receive instructions from the first mobile device sent by a first user, retrieve the instructions and execute the instructions to perform funds transfer. The server infrastructure 207 also generates a transaction id and a security token for a funds transfer initiated by the first user, and it can, if necessary or based on user preferences, transmit the transaction ID and the security token (and other information, such as the name of the sender if specified by the sender) directly to the recipient's mobile device 257, or to the first mobile device 259 so that the first user can somehow (out-of-band, if necessary) have it communicated to the recipient. The server infrastructure 207 can send the transaction id and a security token to the first user or the second user or both based on first user preference.

The first user who receives the transaction id and a security token from the server infrastructure 207 (on the first mobile device 259 or some PC/laptop, or on the source ATM 221, etc.) can have it communicated to the second user via the recipient's mobile device 257, via email, or some other means too if necessary, in one embodiment. In most embodiments, the server infrastructure 207 receives the transaction ID and the security token from the second user, such as via the recipient's mobile device 257, via the delivering ATM 231, or a laptop/PC used by the recipient to complete the funds transfer.

The server infrastructure 207 attempts to verify the transaction ID and the security token (and any other relevant information, such as the transfer amount, etc.) provided by the recipient user, or by the recipient's mobile device 257. The server infrastructure 207 verifies the authenticity of the transaction id and security token (and any other relevant information) received from the second user, and on successful authentication/verification, authorizes the payment of the first amount to the second user (in the form of cash, in the form of digital currencies, etc.)

The server infrastructure 207 (which comprises the at least one computer, among other units, such as a server-farm at a data center) is additionally configured to communicate at least the transaction id and the security token to the recipient's mobile device 257, or to any other second device for the recipient, for review and optional storage (for use later) by the second user. The server infrastructure 207 is further configured to transfer a digital currency equivalent to the first amount (sent by the sender who is the first user) to an account associated with the second user upon successful verification the authenticity of the transaction id and security token.

In one embodiment, the second user (the recipient) identifies an account associated with the second user just before receiving the first amount. This makes it possible for the sender to be flexible, and not have to specify or even know about the recipient's bank account(s), or which of the recipient's bank account specify as a destination for funds transfer or payment. Instead, such specification can be left to the recipient, who, just before receiving the funds, decides to specify one of his bank accounts, credit card account, debit account, investment account, digital wallet, etc, as the destination of the funds transfer. This is a very flexible approach to funds transfer that is conducted based on the recipient's needs and preferences. It recipient's choice can be based on interest rates, or based on which bank is open or closed, or based upon which delivering ATM is operational or convenient to get to.

In one related embodiment, the server infrastructure 207 receives an identify of an account associated with the second user (the recipient) along with the transaction id and the security token and immediately initiates disbursing of the first amount to the account associated with the second user. In another embodiment, the server infrastructure 207 delivers the funds transferred or payment made in the form of digital currency that the recipient can store in a digital wallet, online account, etc. The account associated with the second user is a digital currency wallet of the second user in a related embodiment that is managed by the second user on the recipient's mobile device 257.

The server infrastructure 207 comprises a registration module 247 used to register individuals who want to conduct funds transfer and individuals who want to receive funds being transferred, such as those who frequently receive funds. It also comprises a notification manager 245 that facilitates sending notifications of funds to be transferred to recipients, etc. It has a funds transfer manager 243 that facilitates sending funds, receiving funds, tracking funds as they are transferred, reporting on funds transferred, searching for funds that are yet to be transferred, etc. It comprises a verification manager 241 that helps verify transaction ids and security information presented by recipients via the delivering ATM 231, etc. The server infrastructure 207 also comprises a profile manager 249 and interfaces 261, such as a first interface to source ATM 221, a second interface to the delivering ATM 231 and a third interface to a recipient's mobile device 257, etc.

The server infrastructure 207 communicates transaction id, optional security information and the specified first amount to a recipient's mobile device in order to keep a recipient informed on incoming funds. The delivering ATM 231 receives at least the transaction id and the optional security information from the recipient and communicates it to the server infrastructure 207 for verification before conducting funds transfer.

The security information is a security token or a password in one embodiment. In a related embodiment the security token is a one-time use string of alphanumeric digits. It comprises a ATM machine PIN code in another embodiment, that is used in conjunction with the recipients ATM card.

The delivering ATM 231 captures a first digital image of the recipient and sends it to a sender's mobile device via the server infrastructure to seek approval for conducting funds transfer. The delivering ATM 231 receives, via the server infrastructure 207, an approval for funds transfer received from the sender's mobile device, before conducting funds transfer of the specified first amount, minus a service charge, to the recipient.

In one embodiment, the actual delivering ATM 231 recommended to the recipient as a location/facility for funds transfer is determined based on one or more criteria, such as the location of the recipient (as automatically determined or as specified by the sender, for example), the known location of the delivering ATM 231, the known working hours of the delivering ATM, etc. The server infrastructure 207 determines which delivering ATM 231 among several possible ones is to be targeted as the delivering ATM for the recipient, based on perceived convenience and perceived ease of access. The use of other criteria, such as the preferences of the sender, the preferences of the recipient is also factored in a related embodiment. In yet another related embodiment, a primary delivering ATM 231 is specified to the recipient (such as in an email sent or an SMS notification sent, etc.) along with one or more alternate delivering ATMs. The recipient can approach and use any of those delivering ATMs specified—the primary ones or the alternate ones, to complete the funds transfer activities.

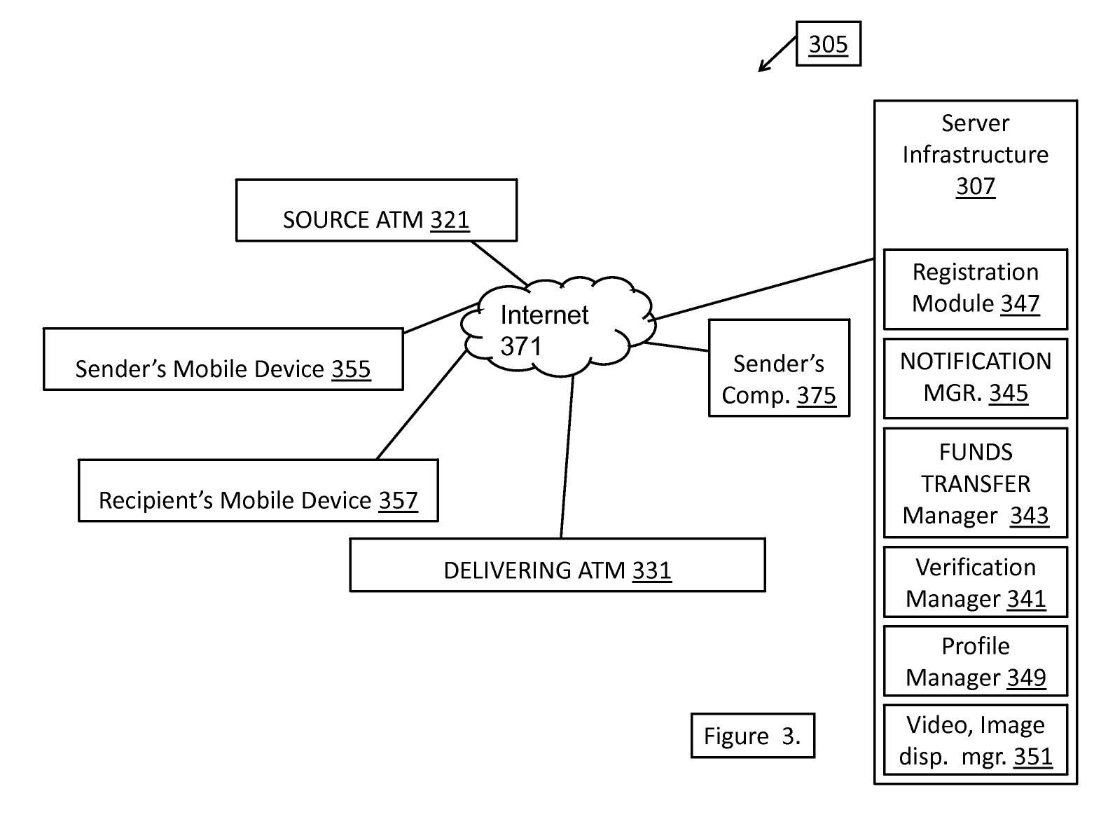

FIG. 3 is a perspective block diagram of a system 305 supporting a plurality of mobile devices used by a plurality of users for managing anonymous funds transfer and banking. A user using sender's mobile device 355 initiates a funds transfer to a recipient who receives a notification of the funds transfer on a recipient's mobile device 357. The recipient is provided a transaction id, a security information, or both in a notification received on the recipient's mobile device 357. The security information is a security token or a password in one embodiment. In a related embodiment the security token is a one-time use string of alphanumeric digits. It comprises a ATM machine PIN code in another embodiment, that is used in conjunction with the recipients ATM card.

The system 305 implements a method for funds transfer and online payment that incorporates anonymously transferring a first funds transfer amount into a first adhoc staging account, retrieving a first identification of the adhoc staging account and a first security information and then initiating a funds transfer transaction by specifying an identify associated with a recipient mobile device. Subsequently, a delivery request is received by a recipient's mobile device 357, for the first funds transfer amount along with the first identification and the first security information. Disbursing the first funds transfer amount to a recipient from the adhoc staging account then occurs upon verification of the first identification and the first security information. Then the adhoc staging account is permanently closed (automatically in some embodiments) after disbursing of funds.

A server infrastructure 307 communicates the first identification of the adhoc staging account and a first security information to the recipient mobile device 357 as a notification to the recipient. The recipient can then draw the funds transferred by specifying the adhoc staging account and the first security information. The identify associated with a recipient mobile device 357 is a mobile phone number, which is provided by the sender, so that the server infrastructure 307 can send a notification to the recipient. The delivery request is sent from the recipient mobile device 357, and the adhoc staging account and the first security information is communicated to the server infrastructure 307 along with the delivery request. The server infrastructure 307 then triggers a message that results in the funds being released from the adhoc staging account to the recipient (or the recipient's account, for example).

In a related embodiment, the recipient uses recipient's mobile device 357 to receive a notification of a funds transfer. The recipient's mobile device 357 prompts the user to subsequently (using an appropriate client application for funds transfer, or using web pages accessed via a browser) to start a funds transfer application, initiate funds delivery, and then provide the adhoc staging account and the first security information (user input is solicited by appropriate prompts). The funds transfer application in the recipient's mobile device 357 also captures a first digital image of the recipient and sends it to a sender's mobile device 355 via the server infrastructure 307 to seek approval for conducting funds transfer. Upon receiving user approval, the funds transfer application in the recipient's mobile device 357 has digital money transferred to it, or has funds delivered to a user account specified by the recipient, or has the funds transferred to the delivering ATM 331 for pickup (when in proximity to the delivering ATM 331, the recipient, using the recipient mobile device, can have funds transferred delivered to him via the delivering ATM 331).

In one embodiment, the recipient uses the delivering ATM 331 to receive the funds transferred. The delivering ATM 331 captures a first digital image of the recipient and sends it to a sender's mobile device 355 via the server infrastructure 307 to seek approval for conducting funds transfer. The delivering ATM 331 receives, via the server infrastructure 307, an approval for funds transfer received from the sender's mobile device 355, before conducting funds transfer of the specified first amount, minus a service charge, to the recipient.

In one embodiment, the delivering ATM 331 receives the transaction id and the security information from the recipient's mobile device 357 (when it is in communicative proximity) and communicates it to the server infrastructure 307 for verification before conducting funds transfer. In a related embodiment, the identification of the recipient's mobile device 357 is provided by the sender via the source ATM 321 and the delivering ATM 331 accepts the transaction id and the security information only from the recipient's mobile device 357 before proving the transferred funds as cash. The identification of the recipient's mobile device 357 is made by an IMEI number retrieved from the recipient's mobile device 357, by a MSISDN associated the recipient's mobile device 357, by a mobile phone number assigned to the recipient's mobile device 357, etc.

In one embodiment, the identification of the recipient's mobile device 357 is provided by the sender's mobile device 355 to the source ATM 321. In another, the sender himself provides such information using user interaction screen & keyboard circuitry 335 on the delivering ATM 331.

In one embodiment, the source ATM 321 is replaced by a laptop of the sender communicatively coupled to a server infrastructure 307 that initiates a funds transfer of the specified first amount to a recipient based on a funds transfer instructions received from a sender employing an existing financial account with funds available managed by the sender. The delivering ATM 331, communicatively coupled to the server infrastructure 307, conducts funds transfer of the specified first amount to the recipient.

The terms “server” and “server infrastructure” as used herein may refer to a set of computing machines, such as those in data centers, or to a portion of a hosted and managed computing services, that performs multiple underlying computational functions and supports various network access, network storage, data manipulation and searching activities. “Server infrastructure” may also refer to scalable configurations of cloud computing resources with middleware, databases and websites. The term “mobile device” as used herein may refer to handheld computers, tablets, mini-tablets, cellular phones, smartphones and personal digital assistants.

The term ATM as used herein may refer to automated teller machines used by banks and other financial institutions that are used by users with bank cards, debit cards or credit cards to withdraw funds, make deposits, make balance inquiries, etc.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A computer-implemented method of making an anonymous funds transfer from a first mobile device to a recipient device, the method comprising:
providing to a host server, confirmation of receipt of funds for a funds transfer from a sender along with recipient device particulars and fund transfer instructions, wherein the receipt of funds is associated with a transfer amount; and
communicating at least a transaction id representing the funds transfer to a recipient device for notifying a recipient;
allowing identification of the funds transfer based at least on the transaction id, thereby enabling redemption of the transfer amount by the recipient;
delivering the transfer amount or a subset thereof to the recipient upon successfully verifying the transaction id; and
communicating a notification to the first mobile device of the sender regarding the successful delivery of the transfer amount to the recipient.

2. The computer-implemented method of claim 1 wherein the receipt of funds from the sender occurs when the sender identifies a sender account associated with the sender and authorizes a withdrawal of the transfer amount from the sender account.

3. The computer-implemented method of claim 1 wherein the delivering the transfer amount to the recipient occurs when the recipient identifies a recipient account associated with the recipient and authorizes a deposit of the transfer amount to the recipient account.

4. The computer-implemented method of claim 1 wherein delivering the transfer amount or a subset thereof to the recipient occurs after the recipient identifies a recipient account at a recipient bank, wherein the recipient account at the recipient bank get credited with the transfer amount or a subset thereof.

5. The computer-implemented method of claim 1 wherein the recipient identifies the recipient account and the recipient bank online employing the recipient device after receiving the communication with the transaction id.

6. The computer-implemented method of claim 1 wherein delivering the transfer amount or a subset thereof to the recipient occurs after the recipient identifies an ATM at a specific location for collecting the transfer amount, or agrees to use an ATM at a location that is recommended, as a venue for receiving the transfer amount or a subset thereof in the form of currency notes.

7. The computer-implemented method of claim 1 wherein delivering the transfer amount or a subset thereof to the recipient occurs in the form of a digital currency of choice specified by the recipient.

8. The computer-implemented method of claim 1 wherein delivering the transfer amount or a subset thereof to the recipient occurs in a currency of choice specified by the recipient.

9. The computer-implemented method of claim 1 wherein receipt of funds from the sender occurs in a currency of choice specified by the recipient.

10. The computer-implemented method of claim 1 wherein receipt of funds from the sender occurs in a digital currency of choice specified by the recipient.

11. The computer-implemented method of claim 1 wherein the recipient account and the recipient bank are determined by the host server based on a search conducted or based on a user preference stored, before the delivering of the transfer amount or a subset thereof to the recipient.

12. A computer-implemented system of providing an anonymous payment from a first mobile device to a second device to enable an electronic payment between a first user and a second user without provision of an account number or name from at least the first user, the computer-implemented system comprising at least one computer wherein the at least one computer is configured to:
receive instructions from the first mobile device sent by a first user;
retrieve the instructions and execute the instructions to perform funds transfer;
generate a transaction id and a security token;
transmit at least the transaction ID and the security token to the first user or the second user or both based on first user preference;
receive the transaction ID and the security token from the second user;
verify the authenticity of the transaction id and security token received from the second user, and on successful authentication, authorize the payment of the first amount to the second user.

13. The computer-implemented system of claim 12 wherein the at least one computer is additionally configured to communicate at least the transaction id and the security token to the second device for review and optional storage by the second user.

14. The computer-implemented system of claim 12 wherein the at least one computer is further configured to:
transfer a digital currency equivalent to the first amount to an account associated with the second user upon successful verification the authenticity of the transaction id and security token.

15. The computer-implemented system of claim 13 wherein the second user identifies an account associated with the second user just before receiving the first amount.

16. The computer-implemented system of claim 12 wherein the system receives an identify of an account associated with the second user along with the transaction id and the security token and immediately initiates disbursing of the first amount to the account associated with the second user.

17. The computer-implemented system of claim 16 wherein the account associated with the second user is a digital currency wallet of the second user that is managed by the second user on the second device.

18. A method for funds transfer and online payment, the method comprising:
anonymously transferring a first funds transfer amount into a first adhoc staging account and retrieving a first identification of the adhoc staging account and a first security information;
initiating a funds transfer transaction by specifying an identify associated with a recipient mobile device;
receiving a delivery request for the first funds transfer amount along with the first identification and the first security information;
disbursing the first funds transfer amount to a recipient from the adhoc staging account upon verification of the first identification and the first security information; and
permanently closing the adhoc staging account after disbursing.

19. The method of claim 18 further comprising:
communicating the first identification of the adhoc staging account and a first security information to the recipient mobile device as a notification to the recipient.

20. The method of claim 18 wherein the identify associated with a recipient mobile device is a mobile phone number and wherein receiving the delivery request occurs from the recipient mobile device.
